(19) United States
(12) Patent Application Publication
(10) Pub. No.: US 2014/0357544 A1
(43) Pub. Date: Dec. 4, 2014

(54) LIQUID CLEANING AND/OR CLEANSING COMPOSITION

(71) Applicant: The Procter & Gamble Company, Cincinnati, OH (US)

(72) Inventors: Denis Alfred GONZALES, Brussels (BE); Michael Leslie GROOMBRIDGE, Newcastle upon Tyne (GB); Michael MCDONNELL, Northumberland (GB)

(73) Assignee: The Procter & Gamble Company, Cincinnati, OH (US)

(21) Appl. No.: 14/281,997

(22) Filed: May 20, 2014

(30) Foreign Application Priority Data
May 29, 2013 (EP) 13169615.5

(51) Int. Cl. C11D 17/00

(52) U.S. Cl. CPC C11D 17/0013
USPC 510/397

(57) ABSTRACT

A liquid cleaning and/or cleansing composition comprising non-spherical and/or non-rolling abrasive cleaning particles derived from a foam structure comprising a plurality of struts, wherein the abrasive cleaning particles comprise a plurality of filler particles at least partly incorporated therein, wherein the particle size of the abrasive cleaning particles is greater than the particle size of the filler particles and wherein the ratio of the mean area-equivalent diameter of the filler particles to the abrasive cleaning particles is from 0.01 to 0.2, the area-equivalent diameter being measured according to ISO 9276-6.

### TECHNICAL FIELD

The present invention relates to liquid compositions for cleaning and/or cleansing a variety of inanimate and animate surfaces, including hard surfaces in and around the house, dish surfaces, hard and soft tissue surface of the oral cavity, such as teeth, gums, tongue and buccal surfaces, human and animal skin or hair, car and vehicles surfaces, etc. More specifically, the present invention relates to liquid scouring compositions comprising suitable particles for cleaning and/or cleansing. Most preferably the present invention relates to a hard surface composition for treating inanimate hard surfaces.

### BACKGROUND OF THE INVENTION

Scouring compositions such as particulate compositions or liquid (incl. gel, paste-type) compositions containing abrasive components are well known in the art. Such compositions are used for cleaning and/or cleansing a variety of surfaces; especially those surfaces that tend to become soiled with difficult to remove stains and soils.

Amongst the currently known scouring compositions, the most popular ones are based on abrasive particles with shapes varying from spherical to irregular. The most common abrasive particles are either inorganic like carbonate salt, clay, silica, silicate, shale ash, perlite and quartz sand or organic polymeric beads like polypropylene, PVC, melamine, urea, polyacrylate and derivatives, and come in the form of liquid composition having a creamy consistency with the abrasive particles suspended therein.

The surface safety profile of such currently known scouring compositions is inadequate alternatively, poor cleaning performances is shown for compositions with an adequate surface safety profile. Indeed, due to the presence of very hard abrasive particles, these compositions can damage, i.e., scratch, the surfaces onto which they have been applied.

To address some of these problems, shaped abrasive particles such as those described in EP 2 338 966 A1 have been developed in order to provide effective cleaning and surface safety. However, there still remains a need to improve the cleaning abilities of abrasive particles as well as simplifying the processability necessary to ensure appropriate particle shape as well as strength.

There is a further need for such abrasive particles to effectively biodegrade into the environment in order to meet the ever important needs of green technology.

It is thus an objective of the present invention to provide a liquid cleaning and/or cleansing composition suitable to clean/cleanse a variety of surfaces, including inanimate and animate surfaces, such hard surfaces in and around the house, dish surfaces, hard and soft tissue surface of the oral cavity, such as teeth, gums, tongue and buccal surfaces, human and animal skin, etc., wherein the composition provides good cleaning/cleansing performance, whilst providing a good surface safety profile, particle grindability, as well as effective biodegradation.

It is an advantage of the compositions according to the present invention that they may be used to clean/cleanse inanimate and animate surfaces made of a variety of materials like glazed and non-glazed ceramic tiles, enamel, stainless steel, Inox®, Formica®, vinyl, no-wax vinyl, linoleum, melamine, glass, plastics, painted surfaces, human and animal skin, hair, hard and soft tissue surface of the oral cavity, such as teeth enamel, gums, tongue and buccal surfaces, and the like.

A further advantage of the present invention is that in the compositions herein, the particles can be formulated at very low levels, whilst still providing the above benefits.

### SUMMARY OF THE INVENTION

The present invention is directed to a liquid cleaning and/or cleansing composition comprising non-spherical and/or non-rolling abrasive cleaning particles derived from a foam structure comprising a plurality of struts, wherein said abrasive cleaning particles comprise a plurality of filler particles at least partly incorporated therein, wherein the particle size of said abrasive cleaning particles is greater than the particle size of said filler particles and wherein the ratio of the mean area-equivalent diameter of said filler particles to said abrasive cleaning particles is from 0.01 to 0.2, the area-equivalent diameter being measured according to ISO 9276-6.

The present invention further encompasses a process generating shaped non-spherical and/or non-rolling abrasive cleaning particles for use in a liquid cleaning and/or cleansing composition, the process comprising the steps of: blending an effective amount of filler particles with one or more thermoplastic or thermoset material precursors to form a homogeneous solution, wherein the filler particles have an area-equivalent diameter of from 1 μm to 70 μm as measured according to ISO 9276-6; foaming the homogeneous solution; and grinding the foam to generate the abrasive particles.

### BRIEF DESCRIPTION OF THE FIGURES

FIG. 1 is drawing showing an illustration how to calculate the tip radius.

FIG. 2 is drawing showing an illustration how to calculate foam strut aspect ratio.

### DETAILED DESCRIPTION OF THE INVENTION

As used herein “abrasive particles” means abrasive cleaning particles derived from fragmenting (by grinding, milling or other suitable processes) a foam structure comprising a plurality of struts.

As used herein “struts” are essentially tubular (solid or hollow) structures exhibiting good resistance to compression across the length thereof. Such essentially tubular structures typically forming an interconnected array of open pore cells therebetween generating the open cell structure of the foam.

As used herein “substantially water-insoluble” means that the material referred to has a solubility of less than 30 g per 100 g of water, preferably less than 20 g per 100 g of water, more preferably less than 10 g per 100 g of water, more preferably less than 5 g per 100 g of water, even more preferably less than 2 g per 100 g of water, most preferably less than 1 g per 100 g of water, at room temperature (20° C.) and atmospheric pressure (101 kPa).

### The Liquid Cleaning/Cleansing Composition

The compositions according to the present invention are designed as cleaners/cleansers for a variety of inanimate and animate surfaces. Preferably, the compositions herein are suitable for cleaning/cleansing surfaces selected from the group consisting of inanimate surfaces, animate surfaces, and combinations thereof.

In a preferred embodiment, the compositions herein are suitable for cleaning/cleansing inanimate surfaces selected from the group consisting of household hard surfaces; dish surfaces; surfaces like leather or synthetic leather; and automotive vehicle surfaces.

In a highly preferred embodiment, the compositions herein are suitable to clean household hard surfaces.

By “household hard surface”, it is meant herein any kind of surface typically found in and around houses like kitchens, bathrooms, e.g., floors, walls, tiles, windows, cupboards, sinks, showers, shower plastified curtains, wash basins, WCs, fixtures and fittings and the like made of different materials like ceramic, vinyl, no-wax vinyl, linoleum, melamine, glass, Inox®, Formica®, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments.

By “dish surfaces” it is meant herein any kind of surfaces found in dish cleaning, such as dishes, cutlery, cutting boards, pans, and the like. Such dish surfaces may be found both in private households as well as in commercial, institutional and industrial environments.

In an another preferred embodiment, the compositions herein are suitable for cleaning/cleansing animate surfaces selected from the group consisting of human skin; animal skin; human hair; animal hair; and inter-dental areas such as teeth, gums and the like.

The compositions according to the present invention are liquid compositions as opposed to a solid or a gas. Liquid compositions include compositions having a water-like viscosity as well as thickened compositions, such as gels and pastes.

In a preferred embodiment herein, the liquid compositions herein are aqueous compositions. Therefore, they may comprise from 65% to 99.5% by weight of the total composition of water, preferably from 75% to 98% and more preferably from 80% to 95%.

In another preferred embodiment herein, the liquid compositions herein are mostly non-aqueous compositions although they may comprise from 0% to 10% by weight of the total composition of water, preferably from 0% to 5%, more preferably from 0% to 1% and most preferably 0% by weight of the total composition of water.

In a preferred embodiment herein, the compositions herein are neutral compositions, and thus have a pH, as is measured at 25° C., of 6 to 8, more preferably 6.5 to 7.5, even more preferably 7.

In other preferred embodiment compositions have pH above 4, preferably above 7, more preferably above 9, most preferably above 10.5 and alternatively have pH preferably from 2 to below 9, preferably from 2.5 to 7.5.

Accordingly, the compositions herein may comprise suitable bases and acids to adjust the pH.

A suitable base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate, all available carbonate salts such as K₂CO₃, Na₂CO₃, CaCO₃, MgCO₃, etc., alkanolamines (as e.g. monoethanolamine), urea and urea derivatives, polyamine, etc.

Typical levels of such bases, when present, are of from 0.01% to 5.0% by weight of the total composition, preferably from 0.05% to 3.0% and more preferably from 0.1% to 0.6%.

The compositions herein may comprise an acid to trim its pH to the required level, despite the presence of an acid, if any, the compositions herein will maintain their preferably neutral pH as described herein above. A suitable acid for use herein is an organic and/or an inorganic acid. A preferred organic acid for use herein has a pKa of less than 6. A suitable organic acid is selected from the group consisting of citric acid, lactic acid, glycolic acid, succinic acid, glutaric acid and adipic acid and a mixture thereof. A mixture of said acids may be commercially available from BASF under the trade name Sokalan® DCS. A suitable inorganic acid is selected from the group consisting hydrochloric acid, sulphuric acid, phosphoric acid and a mixture thereof.

A typical level of such an acid, when present, is of from 0.01% to 5.0% by weight of the total composition, preferably from 0.04% to 3.0% and more preferably from 0.05% to 1.5%.

In a preferred embodiment, the composition according to the present invention contains citric acid, preferably alone or in combination with other acids, at a level of from greater than 0% to less than 0.5% by weight of the composition. It has surprisingly been found that citric acid at this level improves the cleaning effect of the abrasive particles.

In a preferred embodiment according to the present invention the compositions herein are thickened compositions. Preferably, the liquid compositions herein have a viscosity of up to 7500 cps at 20 s⁻¹, more preferably from 5000 cps to 50 cps, yet more preferably from 2000 cps to 50 cps and most preferably from 1500 cps to 300 cps at 20 s⁻¹ and 20° C. when measured with a Rheometer, model AR 1000 (Supplied by TA Instruments) with a 4 cm conic spindle in stainless steel, 2° angle (linear increment from 0.1 to 100 sec⁻¹ in max. 8 minutes).

In another preferred embodiment according to the present invention the compositions herein have a water-like viscosity. By “water-like viscosity” it is meant herein a viscosity that is close to that of water. Preferably the liquid compositions herein have a viscosity of up to 50 cps at 60 rpm, more preferably from 0 cps to 30 cps, yet more preferably from 0 cps to 20 cps and most preferably from 0 cps to 10 cps at 60 rpm and 20° C. when measured with a Brookfield digital viscometer model DV II, with spindle 2.

### Abrasive Cleaning Particles

The liquid cleaning and/or cleansing composition herein comprise abrasive cleaning particles that are selected or synthesized to feature very effective shapes, e.g. defined by macroshape and mesoshape descriptors whereas effective shape of particles are obtained by reducing a foam material into particles.

The applicant has found that non-spherical and/or non-rolling and preferably sharp abrasive cleaning particles provide good soil removal and low surface damage. The applicant has found that very specific particle shapes can be obtained from foam structures and incidentally, the shape of the resulting particles promote effective sliding of the abrasive particles vs. more typical abrasive particles e.g. produced from un-foamed material where rolling movement is rather promoted and is less effective in displacing soil from the surface.

The applicant has found that non-rolling and/or non-spherical abrasive cleaning particles provide good soil removal and low surface damage. Indeed the applicant has found that such shapes provided by grinding foamed structures promote effective sliding of the abrasive particles vs. typical abrasive particles, where rolling movement is rather promoted and which are less effective in displacing soil from the surface.

Additionally, the abrasive particles have preferably a multitude of sharp edges which are typical features of particles produced from foam structures defined by the present invention. The sharp edges of the non-spherical particles are defined by edges having a tip radius below 20 μm, preferably below 8 μm, most preferably from 5 μm to 0.5 μm. The tip radius is defined by the diameter of an imaginary circle fitting the curvature of the edge extremity. The applicant has found that particles obtained from grinding foams typically feature particles with sharp edges that are the result of the foaming process. Blowing agents, either gas or volatilized solvent optionally with/without addition of tensioactifs or polymeric agents, help during the foaming process to sharpen the foam material edges (or struts) owing to the curvature of the expanding bubble.

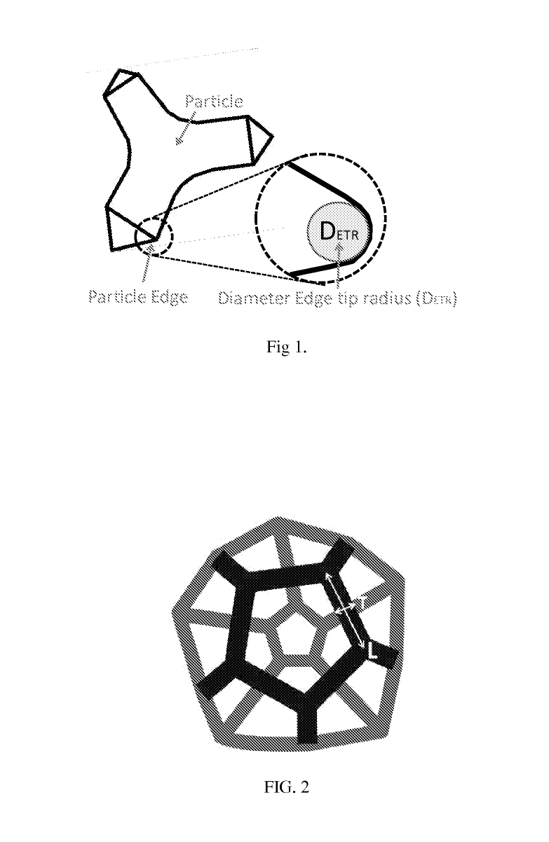

FIG. 1. is an illustration of tip radius.

The abrasive particles are composed of the same foam material from which they are produced. Incidentally, the abrasives can be produced from thermoplastic material comprising foams or from thermoset material comprising foams. Such foams comprise a plurality of struts, typically forming an intricate and reticulated structure with pores therebetween to produce a substantially open cell foam structure with interconnected pores.

Preferably the abrasive particles are made from a material comprising, preferably consisting essentially of, more preferably consisting of, a thermoplastic material, more preferably a biodegradable thermoplastic material preferably selected from the group consisting of biodegradable polyesters preferably selected from the group consisting of polyhydroxy-alkanoates preferably selected from polyhydroxyButyrate, polyhydroxyButyrate-co-valerate, polyhydroxyButyrate-co-hexanoate and mixtures thereof, poly(lactic acid), polycaprolactone, polyesteramide, aliphatic copolyesters, aromatic copolyesters, and mixtures thereof; thermoplastic starch; cellulose esters particularly cellulose acetate and/or nitrocellulose and their derivatives; and mixtures thereof; preferably a blend of a biodegradable polyester and a thermoplastic starch. More preferably the abrasive particles are made from a material comprising, preferably consisting essentially of, more preferably consisting of, a thermoplastic material, more preferably a biodegradable thermoplastic material preferably selected from the group consisting of petroleum-based polyesters preferably selected from the group consisting of polycaprolactone, polyesteramide, aliphatic copolyesters, aromatic copolyesters, and mixtures thereof; thermoplastic starch; cellulose esters particularly cellulose acetate and/or nitrocellulose and their derivatives; and mixtures thereof; preferably a blend of biodegradable petroleum-based polyester and a thermoplastic starch, preferably a blend of polycaprolactone and a thermoplastic starch. Particles made from such materials exhibit good structural properties in terms of hardness and rigidity as well as processability and effective biodegradability.

The abrasive particles of the present invention further comprise, at least partly incorporated therein, substantially water-insoluble filler particles. The abrasive particles having a particle size that is greater than the particle size of the filler particles. The filler particles are sized such that the ratio of the mean area-equivalent diameter of the filler particles to the abrasive cleaning particles mean area-equivalent diameter is from 0.01 to 0.2. Abrasive cleaning particles comprising filler particles so sized exhibit good friability upon shear whilst still being sufficiently resistant to external stresses for good cleaning of a variety of soils on a variety of surfaces. Moreover, such filler particles enable more effective biodegradation of the abrasive particles.

In an embodiment, the filler particles are sized such that the mean area-equivalent diameter of the filler particles is from 0.01 to 0.4, preferably from 0.05 to 0.35, more preferably from 0.1 to 0.3, even more preferably from 0.1 to less than 0.3, most preferably from 0.1 to 0.25, times the mean area-equivalent diameter of the struts of the foam from which the particles are derived.

Particles have size defined by their area-equivalent diameter (ISO 9276-6:2008(E) section 7) also called Equivalent Circle Diameter “ECD” (ASTM F1877-05 Section 11.3.2). Mean ECD (or mean area-equivalent diameter) is calculated as the average of respective ECD of each particles of a particle population desirably of at least 10 000 particles, preferably above 50 000 particles, more preferably above 100 000 particles after excluding from the measurement and calculation the data of the particles having area equivalent diameter (ECD) of below 10 microns. Mean data are extracted from volume-based vs. number-based measurements. The same method is used for measuring the mean ECD of particles (abrasive particles and/or filler particles) as well as of the struts except that for measuring the mean ECD of the filler particles, particles with ECD below 10 microns are not excluded.

In a preferred embodiment the filler particles have a mean area-equivalent diameter of from 1 μm to 70 μm, preferably 1 μm to less than 60 μm, more preferably from 2 μm to less than 50 μm, even more preferably from 2 μm to less than 45 μm, most preferably from 5 μm to less than 30 μm, as measured according to ISO 9276-6 (. If the filler particles are too big, they impact the structural resistance of the abrasive particles which is detrimental to cleaning performance. Particularly desirable are filler particles having mean area-equivalent diameter of less than 50 μm, preferably less than 30 μm, as these provide a good balance between friability, structural strength and biodegradability. Particularly desirable are filler particles having mean area-equivalent diameter of above 1 μm, preferably above 2 μm, and more preferably above 5 μm as these are easily and homogeneously dispersed within the thermoplastic or thermoset matrix thus ensuring homogeneity of physic-chemical performance of the abrasive particles.

Preferably, the abrasive cleaning particles consist essentially of biodegradable abrasive cleaning particles and the thermoset or thermoplastic material consists of a biodegradable material, preferably said biodegradable abrasive cleaning particles having a biodegradability rate of more than 50%, preferably more than 60%, more preferably more than 70% according to ASTM6400 test method.

When the filler particles used comprise a material selected from natural mineral materials such as talk, mica, barium sulfate, wood, walnut, kaolin and the like, the biodegradability rate is calculated based on the biodegradation of the abrasive particle excluding the actual filler. In a preferred embodiment the filler particles comprise a material selected from the group consisting of organic, in-organic and mixtures thereof. Preferably the organic material is selected from vegetal feedstock essentially cellulose or lignocellulose based material e.g.: nut shell, wood, cotton flax or bamboo fibers, corn cob, rice hull, sugars and more generally carbohydrate especially starch from corn, maize, potato, alternatively urea, etc; other plant parts selected from the group consisting of stems, roots, leaves, seeds, and mixtures thereof.

In a preferred embodiment, especially when the matrix material is made of thermoplastic with high crystallinity, the filler is made of starch with high content of amylose and low content of amylopectin (by “low” it is meant less than 10%, preferably less than 5%, more preferably less than 1%, by weight of the starch). Indeed, the amylose are typically low branched carbohydrate that allow fast and efficient crystallisation of the thermoplastic hence promoting better foam formation and material with better mechanical and chemical resilience. Typically, starch filler with amylose content above 30%, preferably above 50% are especially preferred since such have been found not to prevent or significantly reduce the rate of crystallization leading to particles with better strength and shape.

Polymeric fillers may also be used and are selected in order to meet mechanical, rheological and/or hardness requirements. The polymeric fillers are preferably biodegradable and solid at reaction and use temperatures (from 0° C. to 100° C.) to provide effective hardness and mechanical properties of the abrasive particles. Suitable examples of polymer fillers are selected from the group consisting of polyhydroxy-alkanoates, poly(lactic acid), polycaprolactone, polyesteramide, aliphatic copolyesters, aromatic copolyesters, and mixtures thereof; starch; and mixtures thereof.

The fillers may be selected from in-organic material wherein the inorganic material is having a specific gravity of from 1 to 3 and mohs hardness comprised between 1-4. Suitable example of in-organic fillers are derived from sulfate, or carbonate metal salts, such as Ca₂CO₃, MgSO₄, barite, generally phyllosilicate material e.g.; talc, kaolinite, vermiculite, mica, muscovite, pyrophillite, bentonite, montmorrillonite, feldspar, etc, and mixtures thereof.

Alternatively, non-biodegradable polymeric fillers may be used, although it is preferred not to use them in high quantities when substantial biodegradation level of the abrasive particles is desired. In this case, non-biodegradable polymers can be used in quantity not exceeding 10% of the weight of the biodegradable polyurethane. Suitable non-biodegradable polymeric fillers can be selected from the group consisting of polyethylene, polypropylene, polystyrene, polyvinyl chloride (PVC), polyacrylate, non-biodegradable polyurethane, and their derivatives and mixtures thereof.

It is highly preferred that the filler particles are comprised at a level of from 5% to 60%, preferably from 10% to 60%, preferably from greater than 15% to 60%, more preferably from 20% to 60%, most preferably from greater than 30% to 60%, by weight of the composition. Such high levels of filler particles enables to reduce the cost of the abrasives as well as still meeting the structural requirements and improving biodegradability when needed.

In a preferred embodiment, the filler particles are incorporated into the abrasive cleaning particles in such a way that at least part of said filler particles protrude from the outer surface of said abrasive particles. Such is to promote overall particle roughness and improve its cleaning properties.

The applicant has surprisingly further discovered that efficient cleaning result can be achieved with particle population occupying a large volume per mass of particles loaded in a cleaning composition. The volume that the particles will occupy is defined by the packing density of the particles. The packing density of a particle population represents the mass of a sample of particle population divided by the volume occupied by the particles sample measured in dry condition after packing with normal gravity force. Incidentally, a particle population with low packing density will occupy a high volume, both in cleaner and during cleaning operation to provide effective cleaning performance, while a particle sample with high packing density will occupy a low volume, both in cleaner and during cleaning operation hence providing low effective cleaning performance.

Indeed, particles with low packing density are effective at providing maximum contact area between the abrasive particles and the soil and/or surface to be cleaned. And therefore, lower quantity of abrasive particles can be used in cleaning composition i.e., below 10% vs. commonly above 20%, while delivering equal or better cleaning effectiveness. It is commonly known, that higher quantity of particles in the cleaning composition leads to a better cleaning effectiveness, additionally a higher mass of particle was used to maximize the cleaning performance. The applicant has established that the cleaning efficiency is rather impacted by the volume that the abrasive population occupies at the cleaning interface versus typically the mass of the abrasive population. Incidentally, particles with low packing density typically require lower mass load of the abrasive in the cleaner versus high packing density particles to produce efficient cleaning.

However, specifically when generating abrasive particles by fragmenting a foam structure as an example made of a biodegradable thermoplastic material such as biodegradable polyesters (versus for example fragmenting foams made of other polymers such as polyurethanes), too low packing density often results in particles that are more fragile in nature inevitably impacting the cleaning behaviour. Thus, specifically for thermoplastic materials, choosing the correct packing density may be more important.

The applicant has found that abrasive population with high packing density feature low cleaning performance while, on the other hand, abrasive population with lower packing density has intrinsic fragility that is also inadequate for cleaning purpose via mechanical abrasion. Incidentally, the applicant has found out that the abrasive cleaning particles having a packing density from 10 kg/m³ to 250 kg/m³, preferably from greater than 30 kg/m³ to less than 250 kg/m³, more preferably from 50 kg/m³ to 200 kg/m³, even more preferably from 80 kg/m³ to 180 kg/m³, preferably from greater than 100 kg/m³ to 160 kg/m³, more preferably from greater than 100 kg/m³to less than 150 kg/m³, are providing improved cleaning performance and surface safety when the material is a thermoplastic material.

The packing density herein is calculated according to the following method: One tenth of a gram (0.1 g+/−0.001 g) of dry particles is placed into a 20 ml precise metric graduated Pyrex® volumetric cylinder (as available from Sigma-Aldrich). The cylinder is sealed (e.g. with a stopper or film), and subsequently shaken using a Vortex mixer (for example, the model L-46 Power Mix from Labinco DNTE SP-016) at 2500 rpm (maximum speed) for 30 seconds. The volume of the particles is measured after vibration. If the volume is between 5 to 15 ml, this is converted accordingly into packing density as expressed in kg/m3. If the volume of 0.1 g is less than 5 ml, then two tenths of a gram (0.2 g+/−0.001 g) of dry particles is used to re-run the test in clean cylinder. If the volume of the 0.2 g is less than 5 ml, then half a gram (0.5 g+/−0.001 g) of dry particles is used to re-run the test in a clean cylinder. If the volume of the 0.5 g is less than 5 ml, then one gram (1.0 g+/−0.001 g) of dry particles is used to re-run the test in a clean cylinder, with volumes between 3 to 15 ml converted into kg/m3 for packing density.

Foaming processes and foam structures are typically achieved via a gas expansion process, e.g.: either by injecting gas or solvent within the abrasive precursor and allowing expansion by pressure drop and/or increase of temperature, e.g.: extrusion foaming process. In that case, thermoplastic material in a form of pure polymer or polymer blend or plasticized polymers etc. are usually used. Typical gases used in such processes are air, nitrogen, carbon dioxide or organic solvents such as pentane, cyclopentane, etc with or without inclusion of nucleation and foam stabilizing agents. In most cases, a controlled amount of gas is allowed to dissolve into the polymer/polymeric mix into in melted phase whereas the skilled operator can control accurately the foaming parameters e.g.: formulation, time/temperature/pressure cycle parameters to target specific foam structures.

Foaming processes and foam structures are also typically achieved via emulsion foaming of monomers followed by a hardening step via chemical, heat or radiative, e.g.: UV, curing and if necessary followed by a drying step of the solidified foam. Several monomer types are possible to use e.g.: those derived from the non-exhaustive list of the following monomer structures e.g.: vinyl, styrene, acrylate, methacrylate, diene, etc. Examples of materials and foaming and curing process are extensively described in literature (e.g.: refer to the book “Emulsion Polymer Technology” by Robert D. Athey). A preferred route for production of the foam is to form a water/oil High Internal Phase Emulsion of water in the monomer mixture and polymerize in-situ, as described in U.S. Pat. No. 6,369,121 to Catalfamo et al, incorporated by reference herein. In a preferred embodiment the foam is produced after polymerization of a divinyl benzene cross-linked styrene polymer using a water/oil High internal Phase Emulsion process. After curing, the foam is then reduced to particles via a grinding or milling operation.

Foaming processes and foam structures are also typically achieved by mechanical agitation e.g.; battering of a viscous mix e.g.: typically including protein with emulsifying and possibly stabilizing features followed by a step of curing/hardening and if necessary drying of the solidified foam. Non-exhaustive examples of proteins are white egg or pure albumen, gelatin, saponin, gluten, soybean protein, globulin, prolamine, glutelin, histone, protamine, etc. whereas the proteins are often agitated in presence of water, emulsifying agent, stabilizers e.g.: alginic acid, and, very desirably, a significant amount of polymerizable monomer and/crosslinker to achieve sufficient hardness of the foam. For further reference refer to the book “Functionality of Proteins in Food” by Joseph F. Zayas, “Protein Functionality in Food Systems” from Hettiarachchy, Article in Journal of Cereal science 47 (2008) 233-238 by E. Zukowska et Al; or US2006/0065159.

Foaming process are also achieved via typical foaming process involved in foaming polyurethane material via the reaction of isocyanate and polyol reactant as described in application WO2012/177676 and WO2011/133508.

One suitable way of reducing the foam into the abrasive cleaning particles herein is to grind or mill the foam. A grinding process is described in U.S. Pat. No. 6,699,963 B2, in which the polymer is ground in slurry of ice and water. Other suitable means include the use of eroding tools such as a high speed eroding wheel with dust collector wherein the surface of the wheel is engraved with a pattern or is coated with abrasive sandpaper or the like to promote the foam to form the biodegradable abrasive cleaning particles herein. Alternatively and in a highly preferred embodiment herein, the foam may be reduced to particles in several stages. First the bulk foam can be broken into pieces of a few cm dimensions by manually chopping or cutting, or using a mechanical tool such as a lumpbreaker, for example the Model 2036 from S Howes, Inc. of Silver Creek, N.Y., whereas the foam pieces are thereafter ground or milled into finer abrasive particles which have little remaining cell structure by subsequent grinding process e.g.: using a roll mill, rotor mill, jet impact mill, etc.

The applicant has found that efficacious and safe cleaning particles can be produced from foams with very specific structural parameters as described below. Indeed the applicant has found that the structure of the foam allows the shape parameters of the cleaning particles to be controlled and the applicant has demonstrated that the particle shape parameters greatly impact the cleaning performance of the particles. Even more surprisingly, it has been found that the filler particles enable to generate even better abrasive particle shapes than without, the size of which not only impacts such particle shape control but also biodegradability. It is understood that the foam structural parameters described below have a direct impact on the desired particle shape after grinding of the foam into abrasive particles; hence the accurate control of the foam structure is a preferred and convenient means to synthesized efficient abrasive particles.

The applicant has found that a good cleaning effect can be achieved with abrasive particles which have been made from foam having a density above 200 kg/m³, and even up to 500 kg/m³. However the applicant has surprisingly found that a significantly better cleaning effect can be achieved with a foam density below 200 kg/m³, more preferably with a foam density from 10 kg/m³ to 200 kg/m³ and most preferably with a foam density from 30 kg/m³ to 180 kg/m³ and preferably from 50 kg/m³ to 160 kg/m³ Foam density can be measured, for instance, using the protocol described in ASTM D3574.

Similarly, the applicant has found that a good cleaning effect can be achieved with abrasive particles which have been made from foams featuring cell sizes ranging from 20 micrometers to 2000 micrometers. However the applicant has surprisingly found that a significantly better cleaning effect can be achieved with foams featuring cell sizes between 100-1000 micrometers, more preferably from 200 to 500 micrometers and most preferably from 300 to 450 micrometers. Foam cell size can be measured for instance using the protocol described in ASTM D3576.

Similarly, the applicant has found that a good cleaning effect can be achieved with abrasive particles which have been made from foams featuring close-cell structures. However, the applicant has surprisingly found that a significantly better cleaning effect can be achieved with abrasive cleaning particles, which have been reduces into particles from foams with open-cell structure. An open-cell foam structure presents the opportunity to form well defined sharp struts, which in turn produce effective abrasive particles. On the contrary, the presence of closed cells, wherein each cell is closed by foam material extending from each strut into a membrane-like material, produce after grinding into abrasive particles an abrasive population that contains a fraction of flat-shaped residue. This flat-shaped residue is not providing effective cleaning performance, and therefore, is undesirable feature. The shape of this flat-shaped residue is sub-optimal to deliver cleaning. Additionally, these membranes are inherently very fragile and are easily broken into significantly small particles, including undesirable dust, with sizes ranging from several hundred micrometers to sub-micrometer sizes during the grinding of the foam and also during use in the cleaning process. The applicant has found that foam structures with less than 50%, preferably less than 30%, and most preferably less than 15% of closed cells are desirable in producing effective abrasive cleaning particles.

Similarly, the applicant has found that a good cleaning effect can be achieved with abrasive particles which have been made from the foams featuring struts with high aspect ratios. By struts, the applicant defines the elongated material that interconnect to form the cellular structure of the foam, which is best described as a pentagonal dodecahedron structure for the foams with density typically between 50 and 160 kg/m³ targeted herein. The strut length (L) is typically counted as the distance between the geometrical centers of 2 interconnecting knots. The struts thickness (T) is typically the projected strut thickness at the middle of the strut length. The applicant has understood that particles that are derived from foam presenting struts with excessively small L/T ratio present sub-optimal shapes for cleaning since likely to produce rounder particles that readily roll. On the contrary, the particles that are derived from foam presenting struts with excessively high L/T ratio also present sub-optimal shape for cleaning since they are likely to produce excessive amount of rod-like particles featuring low soil removal. Incidentally, the applicant has surprisingly found that significantly better cleaning effect can be achieved with struts having an L/T ratio ranging from 1.5 to 10, preferably from 2.0 to 8.0 and more preferably from 3.0 to 6.0 and most preferred from 3.5 to 4.5 as defined by Visiocell software.

FIG. 2 Pentagonal dodecahedron structure with struts length (L) and thickness (T)

In a preferred embodiment, in order to favor the reduction of the foam into particles, the foam is sufficiently brittle, i.e. upon stress, the foam has little tendency to deform but rather will break into particles.

Efficient cleaning particles are therefore produced by grinding the foam structure with special care to target size and shape. Hence for instance, when large particle size is desired, foam with large cell size is desirable and vice-et-versa. Additionally, in order to preserve an optimal particle shape while grinding the foam structure, it is recommended to not target particle size excessively below the dimension of the cell size of the foam. Typically, the applicant recommends targeting particle size not below about half of the foam cell size. The applicant has found that excessive particle reduction e.g.: vis-à-vis the original foam structure and especially vis-à-vis the cell size yields rounder particles with sub-optimal cleaning efficiency.

In practice, the process to reduce the foam into particle population is set such as the amount of particles with size below half of the average foam cell size is below 30% by weight, preferably below 20% more preferably below 10% and most preferably no particles are detected, whereas the particle size weight proportion is defined by physical sieving method. Note: In order to proceed to the separation of the particles based on size related to half of the average foam cell size, a tolerance of 10% is accepted for the selection of the sieving mesh vis-à-vis the theoretical target sieving grid. The selected sieving mesh tolerance is valid for smaller available sieving mesh vs. the theoretical target size.

Preferred abrasive cleaning particles suitable for used herein are hard enough to provide good cleaning/cleansing performance, whilst providing a good surface safety profile.

The hardness of the abrasive particles reduced from the foam can be modified by changing the raw material used to prepare the foam.

When the abrasive cleaning particles are made of inorganic and/or mineral materials, they may have a hardness expressed accordingly to the MOHS hardness scale. Preferably, the MOHS hardness is comprised between 0.5 and 3.5 and most preferably between 1 and 3. The MOHS hardness scale is an internationally recognized scale for measuring the hardness of a compound versus a compound of known hardness, see Encyclopedia of Chemical Technology, Kirk-Othmer, 4 th Edition Vol 1, page 18 or Lide, D. R (ed) CRC Handbook of Chemistry and Physics, 73 rd edition, Boca Raton, Fla.: The Rubber Company, 1992-1993. Many MOHS Test kits are commercially available containing material with known MOHS hardness. For measurement and selection of abrasive material with selected MOHS hardness, it is recommended to execute the MOHS hardness measurement with un-shaped particles e.g.: with spherical or granular forms of the abrasive material since MOHS measurement of shape particles will provide erroneous results.

When the abrasive cleaning particles are made of materials other than in-organic and/or mineral materials, they may have a hardness from 3 to 50 kg/mm², preferably from 4 to 25 kg/mm² and most preferably from 5 to 15 kg/mm² on the HV Vickers hardness.

Vickers hardness HV is measured at 23° C. according to standard methods ISO 14577-1, ISO 14577-2, ISO 14577-3. The Vickers hardness is measured from a solid block of the raw material at least 2 mm in thickness. The Vickers hardness micro indentation measurement is carried out by using the Micro-Hardness Tester (MHT), manufactured by CSM Instruments SA, Peseux, Switzerland.

As per the ISO 14577 instructions, the test surface should be flat and smooth, having a roughness (Ra) value less than 5% of the maximum indenter penetration depth. For a 200 μm maximum depth this equates to a Ra value less than 10 μm. As per ISO 14577, such a surface may be prepared by any suitable means, which may include cutting the block of test material with a new sharp microtome or scalpel blade, grinding, polishing or by casting melted material onto a flat, smooth casting form and allowing it to thoroughly solidify prior testing.

Suitable general settings for the Micro-Hardness Tester (MHT) are as follows:

Control mode: Displacement, Continuous

Maximum displacement: 200 μm

Approach speed: 20 nm/s

Zero point determination: at contact

Hold period to measure thermal drift at contact: 60s

Force application time: 30s

Frequency of data logging: at least every second

Hold time at maximum force: 30s

Force removal time: 30s

Shape/Material of intender tip: Vickers Pyramid Shape/Diamond Tip

Preferably, the non-spherical particles herein have a multitude of sharp edges. The sharp edges of the non-spherical particles are defined by edge having a tip radius below 20 μm, preferably below 8 μm, most preferably below 5 μm. The tip radius is defined by the diameter of an imaginary circle fitting the curvature of the edge extremity.

In a preferred embodiment, the abrasive cleaning particles have a mean ECD from 100 μm to 600 μm, preferably from 150 to 500 μm, more preferably from 150 μm to 400 μm, even more preferably from 150 to 350 μm.

In one preferred example, the size of the abrasive cleaning particles used in the present invention is modified during usage especially undergoing significant size reduction. Hence the particle remain visible or tactile detectable in liquid composition and at the start of the usage process to provide effective cleaning. As the cleaning process progresses, the abrasive particles disperse or break into smaller particles and become invisible to an eye or tactile undetectable. This effect is better improved by the incorporation of filler particles of the present invention.

It has surprisingly been found that the abrasive cleaning particles of the present invention show a good cleaning performance even at relatively low levels, such as preferably from 0.1% to 10% by weight of the total composition, preferably from 0.1% to 5%, more preferably from 0.5% to less than 5%, even more preferably from 1.0% to 3%, by weight of the total composition of said abrasive cleaning particles.

The particles used in the present invention can be white, transparent or colored by use of suitable dyes and/or pigments. Additionally suitable color stabilizing agents can be used to stabilize desired color. The abrasive particles are preferable color stable particles. By “color stable” it is meant herein that color of the particles used in the present invention will not turn yellow during storage and use.

In one preferred example, the abrasive cleaning particles used in the present invention remain visible when liquid composition is stored into a bottle while during the effective cleaning process abrasive particles disperse or break into smaller particles and become invisible to an eye.

### Optional Ingredients

The compositions according to the present invention may comprise a variety of optional ingredients depending on the technical benefit aimed for and the surface treated.

Suitable optional ingredients for use herein include chelating agents, surfactants, radical scavengers, perfumes, surface-modifying polymers, solvents, builders, buffers, bactericides, hydrotropes, colorants, stabilizers, bleaches, bleach activators, suds controlling agents like fatty acids, enzymes, soil suspenders, brighteners, anti dusting agents, dispersants, pigments, and dyes.

### Suspending Aid

The abrasive cleaning particles present in the composition herein are solid particles in a liquid composition. Said abrasive cleaning particles may be suspended in the liquid composition. However, it is well within the scope of the present invention that such abrasive cleaning particles are not-stably suspended within the composition and either settle or float on top of the composition. In this case, a user may have to temporally suspend the abrasive cleaning particles by agitating (e.g., shaking or stirring) the composition prior to use.

However, it is preferred herein that the abrasive cleaning particles are stably suspended in the liquid compositions herein. Thus the compositions herein comprise a suspending aid.

The suspending aid herein may either be a compound specifically chosen to provide a suspension of the abrasive cleaning particles in the liquid compositions of the present invention, such as a structurant, or a compound that also provides another function, such as a thickener or a surfactant (as described herein elsewhere).

Any suitable organic and inorganic suspending aids typically used as gelling, thickening or suspending agents in cleaning/cleansing compositions and other detergent or cosmetic compositions may be used herein. Indeed, suitable organic suspending aids include polysaccharide polymers. In addition or as an alternative, polycarboxylate polymer thickeners may be used herein. Also, in addition or as an alternative of the above, layered silicate platelets e.g.: Hectorite, bentonite or montmorillonites can also be used. Suitable commercially available layered silicates are Laponite RD® or Optigel CL® available from Rockwood Additives.

Suitable polycarboxylate polymer thickeners include (preferably lightly) crosslinked polyacrylate. A particularly suitable polycarboxylate polymer thickeners is Carbopol commercially available from Lubrizol under the trade name Carbopol 674®.

Suitable polysaccharide polymers for use herein include substituted cellulose materials like carboxymethylcellulose, ethyl cellulose, hydroxyethyl cellulose, hydroxypropyl cellulose, hydroxymethyl cellulose, succinoglycan and naturally occurring polysaccharide polymers like Xanthan gum, gellan gum, guar gum, locust bean gum, tragacanth gum, succinoglucan gum, or derivatives thereof, or mixtures thereof. Xanthan gum is commercially available from Kelco under the tradename Kelzan T.

Preferably the suspending aid herein is Xanthan gum. In an alternative embodiment, the suspending aid herein is a polycarboxylate polymer thickeners preferably a (preferably lightly) crosslinked polyacrylate. In a highly preferred embodiment herein, the liquid compositions comprise a combination of a polysaccharide polymer or a mixture thereof, preferably Xanthan gum, with a polycarboxylate polymer or a mixture thereof, preferably a crosslinked polyacrylate.

As a preferred example, Xanthan gum is preferably present at levels between 0.1% to 5% by weight of the total composition, more preferably from 0.5% to 2%, even more preferably from 0.8% to 1.2%.

### Organic Solvent

As an optional but highly preferred ingredient the composition herein comprises an organic solvents or mixtures thereof.

The compositions herein comprise from 0% to 30% by weight of the total composition of an organic solvent or a mixture thereof, more preferably 1.0% to 20% and most preferably, 2% to 15%.

Suitable solvents can be selected from the group consisting of: aliphatic alcohols, ethers and diethers having from 4 to 14 carbon atoms, preferably from 6 to 12 carbon atoms, and more preferably from 8 to 10 carbon atoms; glycols or alkoxylated glycols; glycol ethers; alkoxylated aromatic alcohols; aromatic alcohols; terpenes; and mixtures thereof. Aliphatic alcohols and glycol ether solvents are most preferred.

Aliphatic alcohols, of the formula R—OH wherein R is a linear or branched, saturated or unsaturated alkyl group of from 1 to 20 carbon atoms, preferably from 2 to 15 and more preferably from 5 to 12, are suitable solvents. Suitable aliphatic alcohols are methanol, ethanol, propanol, isopropanol or mixtures thereof. Among aliphatic alcohols, ethanol and isopropanol are most preferred because of their high vapour pressure and tendency to leave no residue.

Suitable glycols to be used herein are according to the formula HO—CR₁R₂—OH wherein R1 and R2 are independently H or a C₂-C₁₀ saturated or unsaturated aliphatic hydrocarbon chain and/or cyclic. Suitable glycols to be used herein are dodecaneglycol and/or propanediol.

In one preferred embodiment, at least one glycol ether solvent is incorporated in the compositions of the present invention. Particularly preferred glycol ethers have a terminal C₃-C₆ hydrocarbon attached to from one to three ethylene glycol or propylene glycol moieties to provide the appropriate degree of hydrophobicity and, preferably, surface activity. Examples of commercially available solvents based on ethylene glycol chemistry include mono-ethylene glycol n-hexyl ether (Hexyl Cellosolve®) available from Dow Chemical. Examples of commercially available solvents based on propylene glycol chemistry include the di-, and tri-propylene glycol derivatives of propyl and butyl alcohol, which are available from Arco under the trade names Arcosolv® and Dowanol®.

In the context of the present invention, preferred solvents are selected from the group consisting of mono-propylene glycol mono-propyl ether, di-propylene glycol mono-propyl ether, mono-propylene glycol mono-butyl ether, di-propylene glycol mono-propyl ether, di-propylene glycol mono-butyl ether; tri-propylene glycol mono-butyl ether; ethylene glycol mono-butyl ether; di-ethylene glycol mono-butyl ether, ethylene glycol mono-hexyl ether and di-ethylene glycol mono-hexyl ether, and mixtures thereof. “Butyl” includes normal butyl, isobutyl and tertiary butyl groups. Mono-propylene glycol and mono-propylene glycol mono-butyl ether are the most preferred cleaning solvent and are available under the tradenames Dowanol DPnP® and Dowanol DPnB®. Di-propylene glycol mono-t-butyl ether is commercially available from Arco Chemical under the tradename Arcosolv PTB®.

In a particularly preferred embodiment, the cleaning solvent is purified so as to minimize impurities. Such impurities include aldehydes, dimers, trimers, oligomers and other by-products. These have been found to deleteriously affect product odour, perfume solubility and end result. The inventors have also found that common commercial solvents, which contain low levels of aldehydes, can cause irreversible and irreparable yellowing of certain surfaces. By purifying the cleaning solvents so as to minimize or eliminate such impurities, surface damage is attenuated or eliminated.

Though not preferred, terpenes can be used in the present invention. Suitable terpenes to be used herein monocyclic terpenes, dicyclic terpenes and/or acyclic terpenes. Suitable terpenes are: D-limonene; pinene; pine oil; terpinene; terpene derivatives as menthol, terpineol, geraniol, thymol; and the citronella or citronellol types of ingredients.

Suitable alkoxylated aromatic alcohols to be used herein are according to the formula R-(A)ₙ-OH wherein R is an alkyl substituted or non-alkyl substituted aryl group of from 1 to 20 carbon atoms, preferably from 2 to 15 and more preferably from 2 to 10, wherein A is an alkoxy group preferably butoxy, propoxy and/or ethoxy, and n is an integer of from 1 to 5, preferably 1 to 2. Suitable alkoxylated aromatic alcohols are benzoxyethanol and/or benzoxypropanol.

Suitable aromatic alcohols to be used herein are according to the formula R—OH wherein R is an alkyl substituted or non-alkyl substituted aryl group of from 1 to 20 carbon atoms, preferably from 1 to 15 and more preferably from 1 to 10. For example a suitable aromatic alcohol to be used herein is benzyl alcohol.

### Surfactants

The compositions herein may comprise a nonionic, anionic, zwitterionic, cationic and amphoteric surfactant or mixtures thereof. Suitable surfactants are those selected from the group consisting of nonionic, anionic, zwitterionic, cationic and amphoteric surfactants, having hydrophobic chains containing from 8 to 18 carbon atoms. Examples of suitable surfactants are described in McCutcheon's Vol. 1: Emulsifiers and Detergents, North American Ed., McCutcheon Division, MC Publishing Co., 2002.

Preferably, the composition herein comprises from 0.01% to 20% by weight of the total composition of a surfactant or a mixture thereof, more preferably from 0.5% to 10%, and most preferably from 1% to 5%.

Non-ionic surfactants are highly preferred for use in the compositions of the present invention. Non-limiting examples of suitable non-ionic surfactants include alcohol alkoxylates, alkyl polysaccharides, amine oxides, block copolymers of ethylene oxide and propylene oxide, fluoro surfactants and silicon based surfactants. Preferably, the aqueous compositions comprise from 0.01% to 20% by weight of the total composition of a non-ionic surfactant or a mixture thereof, more preferably from 0.5% to 10%, and most preferably from 1% to 5%.

A preferred class of non-ionic surfactants suitable for the present invention is alkyl ethoxylates. The alkyl ethoxylates of the present invention are either linear or branched, and contain from 8 carbon atoms to 16 carbon atoms in the hydrophobic tail, and from 3 ethylene oxide units to 25 ethylene oxide units in the hydrophilic head group. Examples of alkyl ethoxylates include Neodol 91-6®, Neodol 91-8® supplied by the Shell Corporation (P.O. Box 2463, 1 Shell Plaza, Houston, Tex.), and Alfonic 810-60® supplied by Condea Corporation, (900 Threadneedle P.O. Box 19029, Houston, Tex.). More preferred alkyl ethoxylates comprise from 9 to 12 carbon atoms in the hydrophobic tail, and from 4 to 9 oxide units in the hydrophilic head group. A most preferred alkyl ethoxylate is C₉₋₁₁ EO₅, available from the Shell Chemical Company under the tradename Neodol 91-5®. Non-ionic ethoxylates can also be derived from branched alcohols. For example, alcohols can be made from branched olefin feedstocks such as propylene or butylene. In a preferred embodiment, the branched alcohol is either a 2-propyl-1-heptyl alcohol or 2-butyl-1-octyl alcohol. A desirable branched alcohol ethoxylate is 2-propyl-1-heptyl EO7/AO7, manufactured and sold by BASF Corporation under the tradename Lutensol XP 79/XL 79®.

Another class of non-ionic surfactant suitable for the present invention is alkyl polysaccharides. Such surfactants are disclosed in U.S. Pat. Nos. 4,565,647, 5,776,872, 5,883,062, and 5,906,973. Among alkyl polysaccharides, alkyl polyglycosides comprising five and/or six carbon sugar rings are preferred, those comprising six carbon sugar rings are more preferred, and those wherein the six carbon sugar ring is derived from glucose, i.e., alkyl polyglucosides (“APG”), are most preferred. The alkyl substituent in the APG chain length is preferably a saturated or unsaturated alkyl moiety containing from 8 to 16 carbon atoms, with an average chain length of 10 carbon atoms. C₈-C₁₆ alkyl polyglucosides are commercially available from several suppliers (e.g., Simusol® surfactants from Seppic Corporation, 75 Quai d'Orsay, 75321 Paris, Cedex 7, France, and Glucopon 220®, Glucopon 225®, Glucopon 425®, Plantaren 2000 N®, and Plantaren 2000 N UP®, from Cognis Corporation, Postfach 13 01 64, D 40551, Dusseldorf, Germany).

Another class of non-ionic surfactant suitable for the present invention is amine oxide. Amine oxides, particularly those comprising from 10 carbon atoms to 16 carbon atoms in the hydrophobic tail, are beneficial because of their strong cleaning profile and effectiveness even at levels below 0.10%. Additionally C₁₀₋₁₆ amine oxides, especially C₁₂-C₁₄ amine oxides are excellent solubilizers of perfume. Alternative non-ionic detergent surfactants for use herein are alkoxylated alcohols generally comprising from 8 to 16 carbon atoms in the hydrophobic alkyl chain of the alcohol. Typical alkoxylation groups are propoxy groups or ethoxy groups in combination with propoxy groups, yielding alkyl ethoxy propoxylates. Such compounds are commercially available under the tradename Antarox® available from Rhodia (40 Rue de la Haie-Coq F-93306, Aubervilliers Cèdex, France) and under the tradename Nonidet® available from Shell Chemical.

The condensation products of ethylene oxide with a hydrophobic base formed by the condensation of propylene oxide with propylene glycol are also suitable for use herein. The hydrophobic portion of these compounds will preferably have a molecular weight of from 1500 to 1800 and will exhibit water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to 40 moles of ethylene oxide. Examples of compounds of this type include certain of the commercially available Pluronic® surfactants, marketed by BASF. Chemically, such surfactants have the structure (EO)ₓ(PO)_{y}(EO)_{z} or (PO)ₓ(EO)_{y}(PO)_{z} wherein x, y, and z are from 1 to 100, preferably 3 to 50. Pluronic® surfactants known to be good wetting surfactants are more preferred. A description of the Pluronic® surfactants, and properties thereof, including wetting properties, can be found in the brochure entitled “BASF Performance Chemicals Plutonic® & Tetronic® Surfactants”, available from BASF.

Other suitable though not preferred non-ionic surfactants include the polyethylene oxide condensates of alkyl phenols, e.g., the condensation products of alkyl phenols having an alkyl group containing from 6 to 12 carbon atoms in either a straight chain or branched chain configuration, with ethylene oxide, the said ethylene oxide being present in amounts equal to 5 to 25 moles of ethylene oxide per mole of alkyl phenol. The alkyl substituent in such compounds can be derived from oligomerized propylene, diisobutylene, or from other sources of iso-octane n-octane, iso-nonane or n-nonane. Other non-ionic surfactants that can be used include those derived from natural sources such as sugars and include C₈-C₁₆ N-alkyl glucose amide surfactants.

Suitable anionic surfactants for use herein are all those commonly known by those skilled in the art. Preferably, the anionic surfactants for use herein include alkyl sulphonates, alkyl aryl sulphonates, alkyl sulphates, alkyl alkoxylated sulphates, C₆-C₂₀ alkyl alkoxylated linear or branched diphenyl oxide disulphonates, or mixtures thereof.

Suitable alkyl sulphonates for use herein include water-soluble salts or acids of the formula RSO₃M wherein R is a C₆-C₂₀ linear or branched, saturated or unsaturated alkyl group, preferably a C₈-C₁₈ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₂₀ linear or branched saturated or unsaturated alkyl group, preferably a C₈-C₁₈ alkyl group and more preferably a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

An example of a C₁₄-C₁₆ alkyl sulphonate is Hostapur® SAS available from Hoechst. An example of commercially available alkyl aryl sulphonate is Lauryl aryl sulphonate from Su.Ma. Particularly preferred alkyl aryl sulphonates are alkyl benzene sulphonates commercially available under trade name Nansa® available from Albright&Wilson.

Suitable alkyl sulphate surfactants for use herein are according to the formula R₁SO₄M wherein R₁ represents a hydrocarbon group selected from the group consisting of straight or branched alkyl radicals containing from 6 to 20 carbon atoms and alkyl phenyl radicals containing from 6 to 18 carbon atoms in the alkyl group. M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Particularly preferred branched alkyl sulphates to be used herein are those containing from 10 to 14 total carbon atoms like Isalchem 123 AS®. Isalchem 123 AS® commercially available from Enichem is a C₁₂₋₁₃ surfactant which is 94% branched. This material can be described as CH₃—(CH₂)ₘ—CH(CH₂OSO₃Na)—(CH₂)ₙ—CH₃ where n+m=8-9. Also preferred alkyl sulphates are the alkyl sulphates where the alkyl chain comprises a total of 12 carbon atoms, i.e., sodium 2-butyl octyl sulphate. Such alkyl sulphate is commercially available from Condea under the trade name Isofol® 12S. Particularly suitable liner alkyl sulphonates include C₁₂-C₁₆ paraffin sulphonate like Hostapur® SAS commercially available from Hoechst.

Suitable alkyl alkoxylated sulphate surfactants for use herein are according to the formula RO(A)ₘSO₃M wherein R is an unsubstituted C₆-C₂₀ alkyl or hydroxyalkyl group having a C₆-C₂₀ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulfate (C₁₂-C₁₈E(1.0)SM), C₁₂-C₁₈ alkyl polyethoxylate (2.25) sulfate (C₁₂-C₁₈E(2.25)SM), C₁₂-C₁₈ alkyl polyethoxylate (3.0) sulfate (C₁₂-C₁₈E(3.0)SM), C₁₂-C₁₈ alkyl polyethoxylate (4.0) sulfate (C₁₂-C₁₈E, (4.0)SM), wherein M is conveniently selected from sodium and potassium.

Suitable C₆-C₂₀ alkyl alkoxylated linear or branched diphenyl oxide disulphonate surfactants for use herein are according to the following formula:

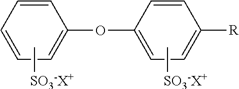

wherein R is a C₆-C₂₀ linear or branched, saturated or unsaturated alkyl group, preferably a C₁₂-C₁₈ alkyl group and more preferably a C₁₄-C₁₆ alkyl group, and X+ is H or a cation, e.g., an alkali metal cation (e.g., sodium, potassium, lithium, calcium, magnesium and the like). Particularly suitable C₆-C₂₀ alkyl alkoxylated linear or branched diphenyl oxide disulphonate surfactants to be used herein are the C₁₂ branched di phenyl oxide disulphonic acid and C₁₆ linear di phenyl oxide disulphonate sodium salt respectively commercially available by DOW under the trade name Dowfax 2A1® and Dowfax 8390®.

Other anionic surfactants useful herein include salts (including, for example, sodium, potassium, ammonium, and substituted ammonium salts such as mono-, di- and triethanolamine salts) of soap, C₈-C₂₄ olefinsulfonates, sulphonated polycarboxylic acids prepared by sulphonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as C₁₄-C₁₆ methyl ester sulfonates; acyl glycerol sulfonates, fatty oleyl glycerol sulfates, alkyl phenol ethylene oxide ether sulfates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside (the nonionic nonsulfated compounds being described below), alkyl polyethoxy carboxylates such as those of the formula RO(CH₂CH₂O)ₖCH₂COO⁻M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Zwitterionic surfactants represent another class of preferred surfactants within the context of the present invention.

Zwitterionic surfactants contain both cationic and anionic groups on the same molecule over a wide pH range. The typical cationic group is a quaternary ammonium group, although other positively charged groups like sulfonium and phosphonium groups can also be used. The typical anionic groups are carboxylates and sulfonates, preferably sulfonates, although other groups like sulfates, phosphates and the like, can be used. Some common examples of these detergents are described in the patent literature: U.S. Pat. Nos. 2,082,275, 2,702,279 and 2,255,082.

A specific example of a zwitterionic surfactant is 3-(N-dodecyl-N,N-dimethyl)-2-hydroxypropane-1-sulfonate (Lauryl hydroxyl sultaine) available from the McIntyre Company (24601 Governors Highway, University Park, Illinois 60466, USA) under the tradename Mackam LHS®. Another specific zwitterionic surfactant is C₁₂₋₁₄ acylamidopropylene (hydroxypropylene) sulfobetaine that is available from McIntyre under the tradename Mackam 50-SB®. Other very useful zwitterionic surfactants include hydrocarbyl, e.g., fatty alkylene betaines. A highly preferred zwitterionic surfactant is Empigen BB®, a coco dimethyl betaine produced by Albright & Wilson. Another equally preferred zwitterionic surfactant is Mackam 35HP®, a coco amido propyl betaine produced by McIntyre.

Another class of preferred surfactants comprises the group consisting of amphoteric surfactants. One suitable amphoteric surfactant is a C₈-C₁₆ amido alkylene glycinate surfactant (‘ampho glycinate’). Another suitable amphoteric surfactant is a C₈-C₁₆ amido alkylene propionate surfactant (‘ampho propionate’). Other suitable, amphoteric surfactants are represented by surfactants such as dodecylbeta-alanine, N-alkyltaurines such as the one prepared by reacting dodecylamine with sodium isethionate according to the teaching of U.S. Pat. No. 2,658,072, N-higher alkylaspartic acids such as those produced according to the teaching of U.S. Pat. No. 2,438,091, and the products sold under the trade name “Miranol®”, and described in U.S. Pat. No. 2,528,378.

### Chelating Agents

One class of optional compounds for use herein includes chelating agents or mixtures thereof. Chelating agents can be incorporated in the compositions herein in amounts ranging from 0.0% to 10.0% by weight of the total composition, preferably 0.01% to 5.0%.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704, 233, Nov. 3, 1987, to Hartman and Perkins. Ethylenediamine N,N′-disuccinic acids is, for instance, commercially available under the tradename ssEDDS from Palmer Research Laboratories.

Suitable amino carboxylates for use herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents for use herein include salicylic acid, aspartic acid, glutamic acid, glycine, malonic acid or mixtures thereof.

### Radical Scavenger

The compositions of the present invention may further comprise a radical scavenger or a mixture thereof.

Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl) butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers, when used, may be typically present herein in amounts up to 10% by weight of the total composition and preferably from 0.001% to 0.5%. The presence of radical scavengers may contribute to the chemical stability of the compositions of the present invention.

### Perfume

Suitable perfume compounds and compositions for use herein are for example those described in EP-A-0 957 156 under the paragraph entitled “Perfume”, on page 13. The compositions herein may comprise a perfume ingredient, or mixtures thereof, in amounts up to 5.0% by weight of the total composition, preferably in amounts of 0.1% to 1.5%.

### Dye

The liquid compositions according to the present invention may be coloured. Accordingly, they may comprise a dye or a mixture thereof.

### Delivery Form of the Compositions

The compositions herein may be packaged in a variety of suitable packaging known to those skilled in the art, such as plastic bottles for pouring liquid compositions, squeeze bottles or bottles equipped with a trigger sprayer for spraying liquid compositions. Alternatively, the paste-like compositions according to the present invention may by packaged in a tube.

In an alternative embodiment herein, the liquid composition herein is impregnated onto a substrate, preferably the substrate is in the form of a flexible, thin sheet or a block of material, such as a sponge.

Suitable substrates are woven or non-woven sheets, cellulosic material based sheets, sponge or foam with open cell structures e.g.: polyurethane foams, cellulosic foam, melamine foam, etc.

### The Process of Cleaning a Surface

The present invention encompasses a process of cleaning and/or cleansing a surface with a liquid composition according to the present invention. Suitable surfaces herein are described herein above under the heading “The liquid cleaning/cleansing composition”.

In a preferred embodiment said surface is contacted with the composition according to the present invention, preferably wherein said composition is applied onto said surface.

In another preferred embodiment, the process herein comprises the steps of dispensing (e.g., by spraying, pouring, squeezing) the liquid composition according to the present invention from a container containing said liquid composition and thereafter cleaning and/or cleansing said surface.

The composition herein may be in its neat form or in its diluted form.

By “in its neat form”, it is to be understood that said liquid composition is applied directly onto the surface to be treated without undergoing any dilution, i.e., the liquid composition herein is applied onto the surface as described herein.

By “diluted form”, it is meant herein that said liquid composition is diluted by the user typically with water. The liquid composition is diluted prior to use to a typical dilution level of up to 10 times its weight of water. A usually recommended dilution level is a 10% dilution of the composition in water.

The composition herein may be applied using an appropriate implement, such as a mop, paper towel, brush (e.g., a toothbrush) or a cloth, or applied directly by hand, soaked in the diluted or neat composition herein. Furthermore, once applied onto said surface said composition may be agitated over said surface using an appropriate implement. Indeed, said surface may be wiped using a mop, paper towel, brush or a cloth.

The process herein may additionally contain a rinsing step, preferably after the application of said composition. By “rinsing”, it is meant herein contacting the surface cleaned/cleansed with the process according to the present invention with substantial quantities of appropriate solvent, typically water, directly after the step of applying the liquid composition herein onto said surface. By “substantial quantities”, it is meant herein between 0.01 lt. and 1 lt. of water per m² of surface, more preferably between 0.1 lt. and 1 lt. of water per m² of surface.

In a preferred embodiment herein, process of cleaning is a process of cleaning household hard surfaces with a liquid composition according to present invention.

Examples Shaped Particle from Foam with Fillers

| | 1 | 2 | 3 | 4 | 5 | 6 |
|---|---|---|---|---|---|---|
| Foam Raw material | PU | PHB | PHB | PHB | PHB | PHBV |
| Filler raw material | STR-P | STR-W | CF | TALC | MICA | STR-R |
| Filler Weight percentage (by | 50 | 20 | 20 | 30 | 30 | 30 |
| weight of total particle) | | | | | | |
| Filler ECD | 10 | 15 | 3 | 10 | 10 | 20 |
| Particle ECD | 250 | 250 | 150 | 200 | 100 | 350 |
| Filler ECD/Particle ECD | 0.04 | 0.06 | 0.02 | 0.05 | 0.1 | 0.057 |
| | 7 | 8 | 9 | 10 | 11 | 12 |
| Foam Raw material | PHBV | PHBV | PHBV | PHBV | PLA | PLA |
| Filler raw material | CF | WF | MICA | PU | STR-M | OS |
| Filler Weight percentage (by | 20 | 15 | 30 | 9 | 40 | 25 |
| weight of total particle) | | | | | | |
| Filler ECD | 5 | 10 | 15 | 30 | 20 | 50 |
| Particle ECD | 100 | 200 | 250 | 250 | 300 | 400 |
| Filler ECD/Particle ECD | 0.05 | 0.05 | 0.06 | 0.12 | 0.067 | 0.125 |

| | 13 | 14 | 15 | 16 | 17 | 18 | 19 | 20 |
|---|---|---|---|---|---|---|---|---|
| Foam Raw material | PLA | PCL | PCL | PBS | PBAT | PBAT | PBAT | TPS |
| Filler raw material | BAS | WAF | PHBV | OS | STR-P | CF | PHBV | KAO |
| Filler Weight percentage (by | 30 | 30 | 30 | 30 | 40 | 30 | 30 | 30 |
| weight of total particle) | | | | | | | | |
| Filler ECD | 3 | 50 | 10 | 45 | 10 | 5 | 10 | 2 |
| Particle ECD | 125 | 400 | 250 | 300 | 250 | 200 | 250 | 125 |
| Filler ECD/Particle ECD | 0.024 | 0.125 | 0.04 | 0.15 | 0.04 | 0.025 | 0.04 | 0.016 |

Symbol foam material:
PU = Polyurethane (CAS number 53862-89-8 or 57029-46-6)
PHB = Polyhydroxybutyrate (CAS number 26063-00-3 ex.: from Tianan or Biomer)
PHBV = Polyhydroxybutyrate-co-valerate (CAS number 80181-31-3 ex.: from Tianan or Biomer)
PLA = Polylactic acid (CAS number 26100-51-6 ex.: from NatureWorks)
PCL = Polycaprolactone (CAS number 24980-41-4 ex. from Perstorp)
PBS = Polybutylene succinate (CAS number 10034-55-6.ex.: from CSM)
PBAT = Polybutylene adipate terephtalate (CAS number 10034-55-6.ex.: from BASF)
TPS = Thermoplastic starch (CAS number 9005-25-8 e.g.: from Aldrich)
Symbol filler material:
STR-M = Starch from Maize (e.g.: from Cargill, Roquette)
STR-R = Starch from Rice (high amylose content (e.g.: from Cargill, Roquette)
STR-W = Starch from Wheat (e.g.: from Cargill, Roquette)
STR-P (e.g.: from Cargill, Roquette)
CF = Cellulose fibers (e.g.: Arbocel from Rettenmaier, eg.: sieved or commuted from Arbocel
UFC 3, M3, M8, M80 BE 600 10TC) or from Compomat)
WF = Wood Fibers (e.g.: sieved or commuted from WF-9-400 from Compomat or from Arbocell
or Lignocel from Rettenmaier e.g.: C320 or from Compomat)
OS = Olive stone (e.g.: sieved or commuted Goonvean, Arbocel OS)
WAF = Walnut flour (e.g.: sieved or commuted Goonvean or Evonik)
CF = Corn fiber (e.g.: sieved or commuted from Rehofix e.g.: MK100, MK300 from Rettenmaier
or from Compomat or from Goonvean)
RH = Rice hull (e.g.: from Compomat)
TALC = Talc (CAS number 14807-96-6 sieved or commuted from Kobo AJM, Ex-15, CT-250
or from Imerys OOSC, Superior M10 DEC)
BAS = Barium sulfate (e.g.: CAS number 7727-43-7 from KOBO or Aldrich)
MICA = Mica (e.g.: CAS number 12001-26-2 sieved or commuted from Mica Y1800, Y3000,
S25 from KOBO)
KAO = Kaolin (e.g.: sieved or commuted from Polwhite B (from Imerys)
PU = Polyurethane (CAS number 53862-89-8 or 57029-46-6)
PHBV = Polyhydroxybutyrate-co-valerate (CAS number 80181-31-ex.: from Tianan or Biomer)

These following compositions were made comprising the listed ingredients in the listed proportions (weight %). Examples 1-16 herein are meant to exemplify the present invention but are not necessarily used to limit or otherwise define the scope of the present invention.

### Examples of Abrasive-Particle Containing Formulations:

Hard surface cleaner Bathroom composition:

| % Weight | 1 | 2 | 3 |
|---|---|---|---|
| C9-C11 EO8 (Neodol 91-8 ®) | 3 | 2.5 | 3.5 |
| Alkyl Benzene sulfonate | | 1 | |
| C12-14-dimethyl Aminoxide | | 1 | |
| n-Butoxy Propoxy Propanol | | 2 | 2.5 |
| Hydrogene Peroxide | 3 | | |
| Hydrophobic ethoxylated polyurethane | 1.5 | 1 | 0.8 |
| (Acusol 882 ®) | | | |
| Lactic Acid | 3 | | 3.5 |
| Citric Acid | | 3 | 0.5 |
| Polysaccharide (Xanthan Gum, Keltrol | 0.25 | 0.25 | 0.25 |
| CG-SFT ® Kelco) | | | |
| Perfume | 0.35 | 0.35 | 0.35 |
| .Abrasive cleaning particle example # | 1 | 2 | 6 |
| .Abrasive cleaning particle load# | 1 | 1 | 1 |
| Water | Balance | Balance | Balance |

| % Weight | 4 | 5 | 6 |
|---|---|---|---|
| Chloridric acid | 2 | | |
| Linear C10 alkyl sulphate | 1.3 | 2 | 3 |
| n-Butoxy Propoxy Propanol | 2 | | 1.75 |
| Citric Acid | | 3 | 3 |
| PolyvinylPyrrolidone (Luviskol K60 ®) | 0.1 | 0.1 | 0.1 |
| NaOH | | 0.2 | 0.2 |
| Perfume | 0.4 | 0.4 | 0.4 |
| Polysaccharide (Xanthan Gum Kelzan T ®, | 0.3 | 0.35 | 0.35 |
| Kelco) | | | |
| .Abrasive cleaning particle example # | 9 | 10 | 11 |
| .Abrasive cleaning particle load# | 2 | 2 | 2 |
| Water | Balance | Balance | Balance |

Hand-dishwashing detergent compositions:

| % Weight | 7 | 8 | 9 |
|---|---|---|---|
| N-2-ethylhexyl sulfocuccinamate | 3 | 3 | 3 |
| C11EO5 | 7 | 14 | |
| C11-EO7 | | | 7 |
| C10-EO7 | 7 | | 7 |
| Trisodium Citrate | 1 | 1 | 1 |
| Potassium Carbonate | 0.2 | 0.2 | 0.2 |
| Perfume | 1 | 1 | 1 |
| Polysaccharide (Xanthan Gum Kelzan T ®, | 0.35 | 0.35 | 0.35 |
| Kelco) | | | |
| .Abrasive cleaning particle example # | 1 | 6 | 9 |
| .Abrasive cleaning particle load# | 1 | 2 | 5 |
| Water (+minor e.g.; pH adjusted to 10.5) | Balance | Balance | Balance |

General degreaser composition:

| % Weight | 10 | 11 |
|---|---|---|
| C9-C11 EO8 (Neodol 91-8 ®) | 3 | 3 |
| N-Butoxy Propoxy Propanol | 15 | 15 |
| Ethanol | 10 | 5 |
| Isopropanol | | 10 |
| Polysaccharide (Xanthan Gum-glyoxal modified | 0.35 | 0.35 |
| Optixan-T) | | |
| .Abrasive cleaning particle example # | 15 | 19 |
| .Abrasive cleaning particle load# | 2 | 3 |
| Water (+minor e.g.; pH adjusted to alkaline pH) | Balance | Balance |

Scouring composition:

| % Weight | 12 | 13 | 14 |
|---|---|---|---|
| Sodium C13-16 prafin sulfonate | 2.5 | 2.5 | 2.5 |
| C12-14-EO7 (Lutensol AO7 ®) | 0.5 | 0.5 | 0.5 |
| Coconut Fatty Acid | 0.3 | 0.3 | 0.3 |
| Sodium Citrate | 3.3 | 3.3 | 3.3 |
| Sodium Carbonate | 3 | 3 | 3 |
| Orange terpenes | 2.1 | 2.1 | 2.1 |
| Benzyl Alcohol | 1.5 | 1.5 | |
| Polyacrylic acid 1.5 Mw | 0.75 | 0.75 | 0.75 |
| Diatomaceous earth (Celite 499 ® | 25 | | |
| median size 10 μm) | | | |
| Calcium Carbonate (Merk 2066 ® | | 25 | |
| median size 10 μm) | | | |
| .Abrasive cleaning particle example # | 1 | 6 | 19 |
| .Abrasive cleaning particle load# | 5 | 5 | 5 |
| Water | Balance | Balance | Balance |

Liquid glass cleaner:

| % Weight | 15 | 16 |
|---|---|---|
| Butoxypropanol | 2 | 4 |
| Ethanol | 3 | 6 |
| C12-14 sodium sulphate | 0.24 | |
| NaOH/Citric acid | To pH 10 | |
| Citric Acid | | |
| .Abrasive cleaning particle example # | 5 | 5 |
| .Abrasive cleaning particle load# | 0.5 | 0.5 |
| Water (+minor) | Balance | Balance |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid cleaning and/or cleansing composition comprising non-spherical and/or non-rolling abrasive cleaning particles derived from a foam structure comprising a plurality of struts, wherein said abrasive cleaning particles comprise a plurality of filler particles at least partly incorporated therein, characterized in that the particle size of said abrasive cleaning particles is greater than the particle size of said filler particles and wherein the ratio of the mean area-equivalent diameter of said filler particles to said abrasive cleaning particles is from about 0.01 to about 0.2, the area-equivalent diameter being measured according to ISO 9276-6.

2. The liquid cleaning and/or cleansing composition according to claim 1 wherein the abrasive cleaning particles have a packing density of greater than about 100 kg/m³ to less than about 150 kg/m³.

3. The liquid cleaning and/or cleansing composition according to claim 1 wherein the abrasive cleaning particles comprise, a biodegradable material, and that the abrasive cleaning particles are biodegradable abrasive cleaning particles having a biodegradability rate of more than about 50% according to ASTM6400 test method.

4. The liquid cleaning and/or cleansing composition according to claim 1 wherein the filler particles have an area-equivalent diameter of from about 1 μm to about 70 μm, as measured according to ISO 9276-6

5. The liquid cleaning and/or cleansing composition according to claim 1 wherein the filler particles have an area-equivalent diameter of from about 2 μm to 50 μm, as measured according to ISO 9276-6

6. The liquid cleaning and/or cleansing composition according to claim 1 wherein the filler particles have an area-equivalent diameter of from about 2 μm to less than about 45 μm, as measured according to ISO 9276-6

7. The liquid cleaning and/or cleansing composition according to claim 1 wherein the filler particles have an area-equivalent diameter of from about 5 μm to less than about 30 μm, as measured according to ISO 9276-6.

8. The liquid cleaning and/or cleansing composition according to claim 1 wherein the filler particles comprise a material selected from the group consisting of organic, in-organic and mixtures thereof, wherein the organic material is selected from vegetal feedstock essentially cellulose or lignocellulose based material selected from nut shell, wood, cotton, flax or bamboo fibers, corn cob, rice hull, sugars and/or more generally carbohydrates especially starch preferably from corn, maize, potato, or urea; other plant parts selected from the group consisting of stems, roots, leaves, seeds; polyesters; biodegradable polyesters selected from the group consisting of polyhydroxy-alkanoates, poly(lactic acid), polycaprolactone, polyesteramide, aliphatic and/or copolyesters, and mixtures thereof; and mixtures thereof.

9. The liquid cleaning and/or cleansing composition according to claim 8 wherein the in-inorganic material is selected from the group consisting of carbonate or sulfate salt, phyllosilicate material and mixtures thereof.

10. The liquid cleaning and/or cleansing composition according to claim 1 wherein the filler particles are comprised at a level of from greater than about 15% to about 60 by weight of the abrasive cleaning particle.

11. The liquid cleaning and/or cleansing composition according to claim 1 wherein the filler particles are comprised at a level of from greater than about 30% to about 60%, by weight of the abrasive cleaning particle.

12. The liquid cleaning and/or cleansing composition according to claim 1 wherein the biodegradable material is a selected from the group consisting of biodegradable thermoplastic polyesters preferably selected from the group consisting of polyhydroxy-alkanoates selected from polyhydroxyButyrate, polyhydroxyButyrate-co-valerate, polyhydroxyButyrate-co-hexanoate and mixtures thereof, poly(lactic acid), polycaprolactone, polyesteramide, aliphatic and/or, aromatic copolyesters selected from co-polyester containing mix of succinic, adipic, terepthalic diacids, propanediol, butanediol, pentanediol monomer and mixtures thereof; thermoplastic starch; and mixtures thereof.

13. The liquid cleaning and/or cleansing composition according to claim 1 wherein the filler material is a high amylose containing starch material wherein the amylose content is above about 30%, of the total starch weight.

14. The liquid cleaning and/or cleansing composition according to claim 1 wherein the filler particles are substantially water-insoluble.

15. The liquid cleaning and/or cleansing composition according to claim 1 wherein the filler particles are water-soluble and are comprised at a level of less than about 30%, by weight of the abrasive cleaning particle.

16. A process for generating shaped non-spherical and/or non-rolling abrasive cleaning particles for use in a liquid cleaning and/or cleansing composition, said process comprising the steps of:
i. blending an effective amount of filler particles with one or more thermoplastic materials to form a homogeneous solution, wherein said filler particles have an area-equivalent diameter of from 1 μm to 70 μm as measured according to ISO 9276-6;
ii. foaming the homogeneous solution; and
iii. grinding the foam to generate biodegradable abrasive particles.

17. The process according to claim 16 wherein the effective amount of filler particles is more than 15%, by weight of the composition of the abrasive cleaning particle.

18. The process according to claim 16 wherein the filler particles are substantially water-insoluble and preferably have a mean area-equivalent diameter of from about 2 μm to less than about 45 μm, as measured according to ISO 9276-6.

19. The process according to claim 16 wherein the foaming step ii is achieved via extrusion foaming wherein the filler particles further act as nucleating agent to promote speed of crystallization, the blended composition of step i further comprising from about 3 to about 15% by weight of a blowing agent at temperature of from about 80 to about 240° C. and pressure of from about 0.5 to about 30 MPa prior to undergoing a depressurization step at a rate of greater than about 0.5 MPa/s and less than about 10 MPa/s, the temperature ranging from the melt temperature of the thermoplastic material, Tm, to Tm minus about 60° C.

20. The process according to claim 16 wherein step iii comprises the steps of converting the foam into foam pieces ranging from about 1 mm to about 100 mm in the larger dimension thereof followed by grinding said foam pieces into particles having a mean area-equivalent diameter ranging from about 100 to about 350 microns by means of a device selected from eroding wheel, roll grinder, rotor mill, blade mill, jet mill, and combinations thereof, wherein the grinding temperature is controlled to remain below T, wherein T=Tm−Tn, and Tn is about 30° C.
